(19) United States
(12) Patent Application Publication
(10) Pub. No.: US 2022/0376899 A1
(43) Pub. Date: Nov. 24, 2022

(54) USING UNIQUE IMAGE OR PHOTO TO SECURE DATA FOR MOBILE PAYMENT APPLICATIONS AND NETWORKS

(71) Applicant: Michael Alexander, Arlington, TX (US)

(72) Inventor: Michael Alexander, Arlington, TX (US)

(21) Appl. No.: 17/328,769

(22) Filed: May 24, 2021

(51) Int. Cl. H04L 9/08; G06Q 20/32; G06Q 20/38

(52) U.S. Cl. CPC H04L 9/0825; G06Q 20/3274; G06Q 20/38215; H04L 2209/38; H04L 2209/56

(57) ABSTRACT

An image or photo on a smart device is reduced to its base binary format and transmitted to a secured server during a negotiation with a client. The binary data received is separated into an encrypted Public Key and an encrypted Private Key on the secured server. The encrypted public key is sent back to the smart device as encrypted data. The public key encrypted data incorporates the PSI and financial data into a dynamic blockchain string and transmits the encrypted dynamic blockchain data back to the secured server via secured web services for decryption. The encrypted private key residing on the secured server decrypts the incoming encrypted personal sensitive information, executes the transaction and transmits the transaction data to multiple secured databases located across multiple encrypted servers located on multiple secured server farms.

### CROSS-REFERENCES TO RELATED APPLICATIONS

(Not Applicable)

### STATEMENT REGARDING FEDERALLY SPONSORED RESEARCH AND DEVELOPMENT

(Not Applicable)

### REFERENCE TO AN APPENDIX

(Not Applicable)

### BACKGROUND OF THF INVENTION

### 1. Technical Field

The present disclosure relates to systems and methods for mobile payment applications, and more particularly, using a unique image located on a smart device or an image taken with the smart device camera. These images are reduced to the base binary format and use this binary data for encrypting the financial transaction with the application.

### 2. Background

Payment transactions and other financial operations may be implemented using a smart phone or other computerized hardware device. The device may be used for transactions at a point of sale (POS) over a wireless communications channel and require no additional hardware. A transaction generally requires protection of personal sensitive information (PSI). There is a need in the art for a smart device on which a user can take a picture or select an image from the smart device photo gallery and reduce the image to its base binary format and data for use in mobile negotiations. This process is executed in milli-seconds and never puts the users financial data in harm's way

### SUMMARY

In certain example embodiments described herein, methods and systems secure an image or photo from a smart device for use in mobile payment applications. The image chosen by the user is reduced by the application to its basic binary format. The total image binary data is sent to a secured server that separates the binary data into an encrypted public and encrypted private key. An encrypted public key is created by the secured server and is sent back to the smart device for inclusion of Personal Sensitive Information data from the smart device. The encrypted private key portion of the image data remains residing on the secured-server for decryption purposes. The smart device uses the encrypted public key from the secured server to encrypt personal account and/or financial transaction information and transmits the complete encrypted data back to the secured server via secured web services for decryption by the encrypted private key residing on the secured server from the previous binary information. The encrypted private key data decrypts the incoming encrypted data from the smart device. The server then executes the transaction and transmits, stores the transaction data to a secured database network to await the next transaction.

### BRIEF DESCRIPTION OF THE SEVERAL VIEWS OF THE DRAWINGS

FIG. 1 is a block diagram 100 depicting steps of a mobile smart device image generation or stored photo retrieval 110, reduction of the data to a binary format by the application 120, and transmission of the data to a server 130, in a mobile transaction system in accordance with one or more of the embodiments herein. The mobile smart device may be a mobile phone, smartphone, handheld computer, personal digital assistant (PDA), netbook computer, laptop computer, tablet computer, or similar wired or wireless, processor-driven device.

FIG. 2 is a block diagram 200 depicting steps of the server separating the binary data into two encrypted components 210, retaining one portion; the encrypted private key, on the server 220 and transmitting the public encrypted key to the smart device 230, in a mobile transaction system in accordance with one or more of the embodiments herein.

FIG. 3 is a block diagram 300 depicting steps of the smart device combining one portion with information 310 and streaming that data to the server 320, where the retained encrypted private key decrypts and distributes the information to an encrypted database network 330, in accordance with one or more of the embodiments herein.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose.

### DETAILED DESCRIPTION OF THE INVENTION

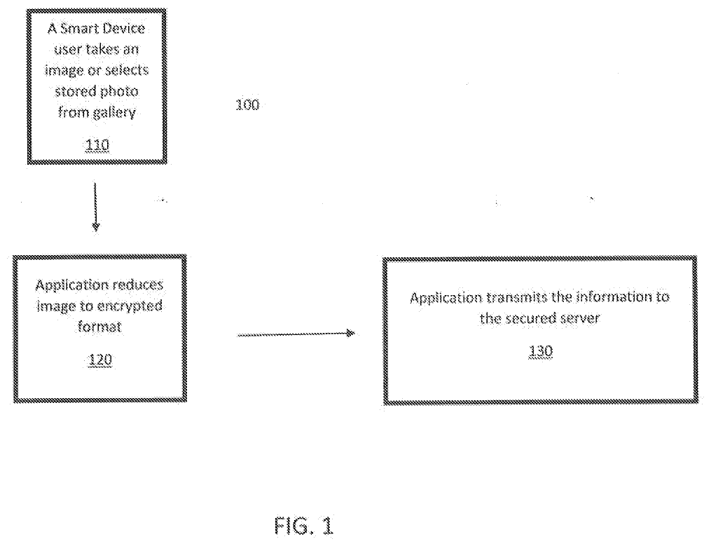

The invention described herein is a smart device application. The application enables use of the smart device to take an image or retrieve a photo from the smart device gallery for use in immediate mobile payment applications. FIG. 1 is a block diagram displaying the first steps of using the smart device for taking an image or selecting a photo. The image or photo data is reduced to an binary format by the application and is transmitted to a secured server.

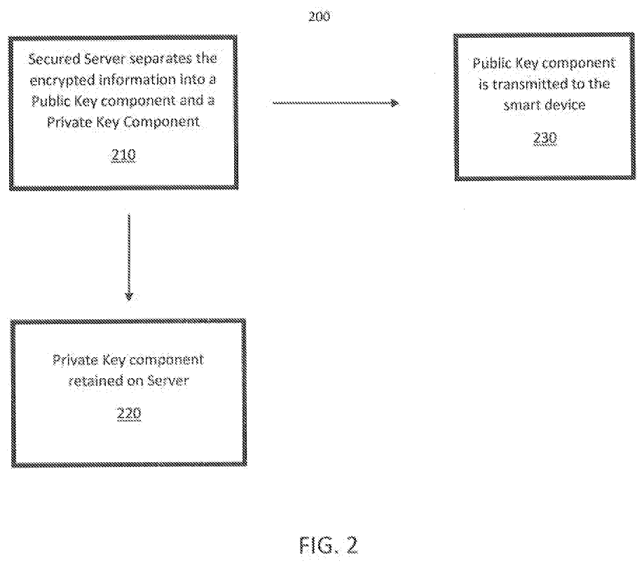

FIG. 2 displays the steps of the server dividing the data into two components. An encrypted Public Key component is formed and transmitted to the smart device and an encrypted Private Key component retained on the server.

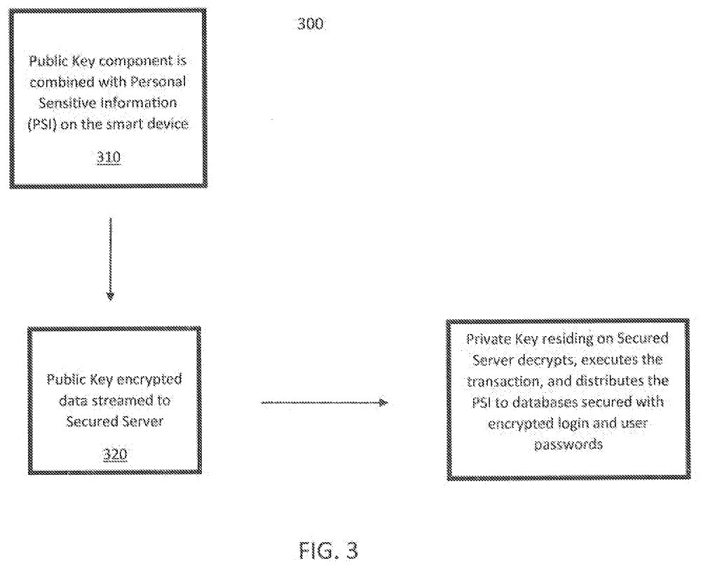

FIG. 3 depicts the steps of the application on the smart device combining the encrypted Public Key information with the user's Personal Sensitive Information (PSI) and financial transaction on the smart device. The application performs and undergoes the identification, authentication, payment credential verification, and financial transaction submission to the secured server. That encrypted data is then transmitted back to the secured server. The encrypted Private Key component residing on the server decrypts the incoming data and executes the transaction. The secured server then distributes the information to the secured network of databases. Each database in the network is secured with the encrypted logins and user passwords.

In conclusion, the present invention has assuredly achieved anticipated effectiveness, moreover, contents of the present invention have not been publicly disclosed prior to this application, and novelty, advancement and industrial practicability of the present invention clearly comply with essential elements as required for a new patent application. Accordingly, a new patent application is proposed herein.

1. A computer-implemented method, comprising:
obtaining an image with a computer device;
reducing said image to an encrypted binary format;
sending said binary data to a secured server;
separating said binary data into an encrypted public key and an encrypted private key,
whereby said encrypted public key data is returned to said smart device, generating a dynamic blockchain data string that comprises said encrypted data; transmitting the generated dynamic blockchain string to another computer system for decryption; and,
whereby said encrypted private key decrypts said encrypted dynamic blockchain string, executes the transaction, sends the encrypted transaction to a set of secured databases located across multiple encrypted network servers.
